(19) United States
(12) Patent Application Publication
(10) Pub. No.: US 2025/0002106 A1
(43) Pub. Date: Jan. 2, 2025

(54) PLANAR DEVICE FOR PEDAL EQUIPPED APPARATUS

(71) Applicant: Michael Montgomery, San Jose, CA (US)

(72) Inventor: Michael Montgomery, San Jose, CA (US)

(21) Appl. No.: 18/754,848

(22) Filed: Jun. 26, 2024

Related U.S. Application Data
(60) Provisional application No. 63/510,850, filed on Jun. 28, 2023.

(51) Int. Cl. B62J 21/00; B62M 3/08

(52) U.S. Cl. CPC B62J 21/005; B62M 3/08

(57) ABSTRACT

A planar device for a pedal-equipped apparatus with a planar member attached to the inward portion of a pedal to protect a rider's body and/or clothing from contact with equipment components during the entire circular pedal rotation. This member may change from a closed, unexpanded position to an expanded position.

### CROSS-REFERENCE TO RELATED APPLICATIONS

I hereby claim benefit under Title 35, United States Code, Section 119(e) of U.S. provisional patent application Ser. No. 63/510,850 filed Mar. 27, 2006. The 63/510,850 application is currently pending. The 63/510,850 application is hereby incorporated by reference into this application.

### PRIOR ART

All prior art related to pedal-attached devices appear not to be able, or in fact designed, to protect the rider's entire lower leg and all relevant clothing (shoes, shoelaces, pants, socks, etc) from contact with all equipment components (e.g. chain, chain ring, derailleur, etc) during the entire circular pedal rotation. See: 1. Deng U.S. D671,039 (2012)/US 2011/0283829 (2011), 2. Davis US 2019/0382077 (2019), 3. Carlson US 2021/0101659 (2021), 4. Nutile U.S. Pat. No. 5,456,138 (1995), 5. Giffin U.S. Pat. No. 5,078,026 (1992)

### BACKGROUND OF THE INVENTION

The present application relates to devices for pedal equipped devices, including but not limited to bicycles and stationary exercise equipment that include pedals.

### SUMMARY OF THE INVENTION

Accordingly, there is disclosed herein a planar device for pedal equipped apparatus, illustratively implemented as a device for a pedaling system, comprising: a planar member configured to attach to an inward portion of a pedal, the planar member capable of changing from a closed position to an expanded position thereby forming a planar surface, such that the planar member is substantially perpendicular to a tread surface of the pedal; whereby the planar member is capable of maintaining a fixed position relative to a tread surface of the pedal when the pedal is mounted to a crank arm and moved in a circular pedaling motion.

### BRIEF DESCRIPTION OF DRAWINGS

FIG. 1 is an exploded perspective view of a first embodiment

FIG. 2 is an right elevation view of a first embodiment, in a closed position

FIG. 3 is an right perspective view of a first embodiment, in an open position

FIG. 4 is an right perspective view of a second embodiment, in a closed position

FIG. 5 is an right perspective view of a second embodiment, in an open position

FIG. 6 is a top view of a third embodiment

FIG. 7 is a side perspective view of a third embodiment

FIG. 8 is a top view of a fourth embodiment

FIG. 9 is a top view of a fifth embodiment in a closed position

FIG. 10 is a top view of a fifth embodiment in a partially open position

FIG. 11 is a top view of a fifth embodiment in a fully open position

FIG. 12 is a perspective view of a sixth embodiment

FIG. 13 is a top view of a seventh embodiment

### DETAILED DESCRIPTION OF THE INVENTION

Note that the specific embodiments given in the drawings and following description do not limit the disclosure. On the contrary, they provide the foundation for one of ordinary skill to discern the alternative forms, equivalents, and modifications that are contemplated by the inventor and encompassed in future claims.

The numerous embodiments shown herein may use components that are interchangeable between some or all of the different embodiments. As will be further detailed, there are at least three different configurations of planar members shown and described (planar disc, panel, fixed screen), at least two different configurations of attachments between a planar member and a pedal (axle mount, pedal body mount—with latter including sub variations), and different configurations for each to collapse, expand, and move into stored positions. Herein, planar describes a surface that is substantially planar, and such a surface may include ridges, curves, etc. Such a planar member may be positioned substantially parallel to the plane of a chainring—that is, the two planes may be angled relative to each other by an appropriate amount to allow fitment and clearance on the pedal-powered device, such as by up to 10 degrees.

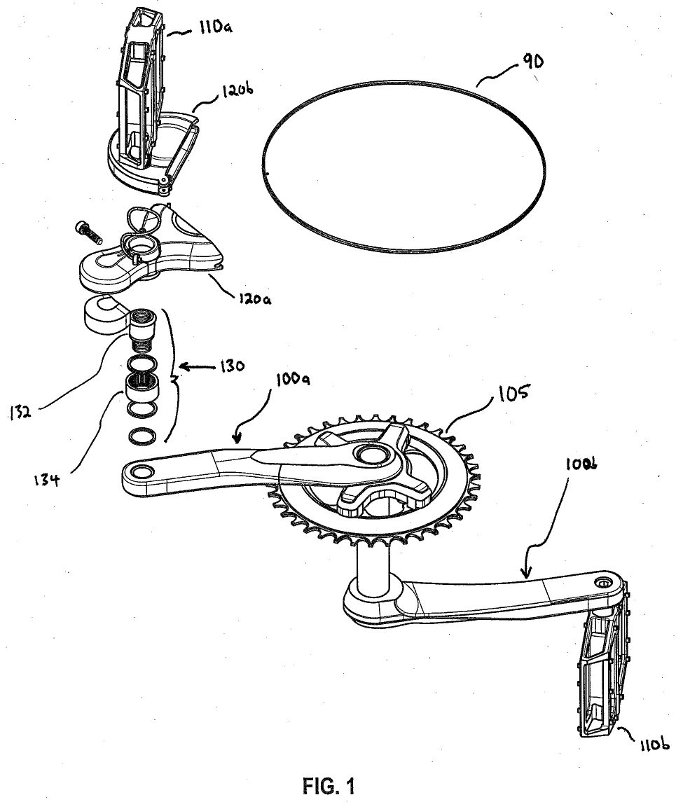

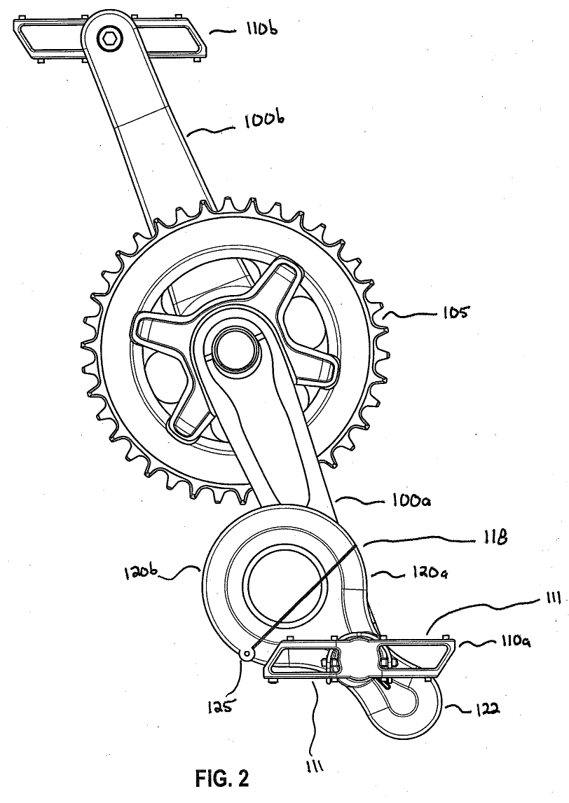

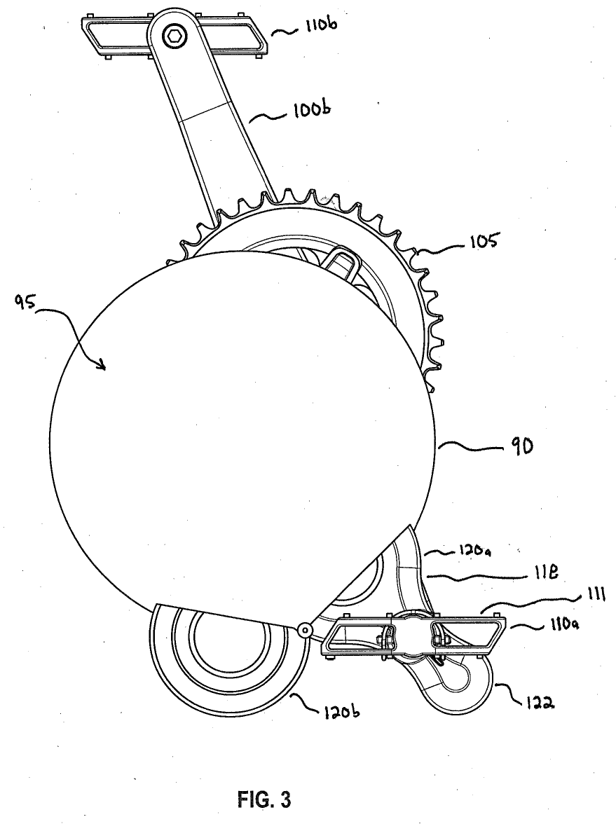

FIG. 1 shows a first embodiment of the current disclosure, and is best understood with additional reference to FIG. 2 and FIG. 3. Herein there are two crankarms 100a and 100b, and pedals 110a and 110b. Each pedal has a tread surface 111 located on each planar portion of the pedal (sometimes in a symmetric, mirror image as shown), which engages with the foot of a cyclist. Such components form part of the drivetrain of pedaling systems for bicycles, pedal-activated stationary exercise equipment, and similar devices. On such systems, a drivechain engages with the teeth of a chainring, such as those on the outer perimeter of chainring 105.

The system also is applicable to devices that use a drivebelt, rather than a drivechain—herein, chainring and chain are used for brevity, but such terms also denote drivebelts and their associated drivesprockets. In the example of a bicycle, a cyclist's feet engage with the pedals, to turn the two crankarms in circular motion. This of course causes each pedal to rotate around each pedal axle as well.

As seen in FIGS. 1-3, there may be a case 118 with a first section 120a, a second section 120b, and a third section 122. The first two portions may be joined together at hinged joint 125, allowing the case to be in open or closed positions. A collapsible/expandable planar disc 90 may be housed in a collapsed stored position in the hollow interior portion of case 118. In FIG. 2 planar disc 90 is contained inside the closed case 118 in a collapsed position, while in FIG. 3 case 118 is open, showing planar disc 90 in an expanded position. In its expanded position, planar disc 90 forms a planar surface 95.

In this embodiment, planar disc 90 is approximately circular, and formed by a rigid yet foldable hoop (typically metal, plastic, or composite) at the outer perimeter, with a center portion made of foldable material such as fabric (nylon, cotton, spandex, etc). Thus, planar disc has minimal thickness, that only of the fabric and thin hoop. Such collapsible discs are known in the art, and will not be further detailed herein.

FIG. 1 details one of a number of mechanisms for joining case 118 to a drivetrain of a bicycle. Herein, threaded assembly 130 accommodates a pedal such as 110a and case 118, allowing the male threads of a pedal axle to screw into the threaded bore of coupler 132, and the male threads of the coupler to screw into the threaded bore of crankarm 100a. Bearing 134, herein a cylindrical-type roller bearing, also forms part of threaded assembly 130, along with various washers shown. Herein, this may be referred to as an axle mount system.

As seen in FIG. 3, when planar disc 90 is in its expanded position, it forms a planar surface 95 that is substantially parallel to that of chainring 105 (and the related drivechain, not shown). As a cyclist pedals a bicycle on which the present embodiment is fitted, planar surface 95 may act as a guard to prevent contact between a cyclist's body and/or clothing, and the drivetrain of the bicycle—particularly a guard against a chainring such as 105 (and the related drivechain, not shown). Planar disc 90 is allowed to rotate independently of crankarm 100a and pedal 110a, due to bearing 134. As seen in FIG. 3, third section 122 of case 118 is positioned below pedal 110a, with case 118 free to rotate around the axle of pedal 110a. Third section 122 may serve as a counterweight and/or anchoring effect, such that when crankarm 100a is rotated (as in the pedaling motion of a bicycle), planar surface 95 maintains its relative position to the pedal's tread surface(s) 111. Of course, other configurations may be used to create a counterweight and/or anchoring effect, to maintain the relative position of planar surface 95. Thus, planar surface 95 maintains a desired position throughout the rotation of the cranks, thereby serving as a guard for clothing and body through the entire 360 degrees of crank movement.

FIGS. 1-3 show a first embodiment of the present disclosure, however there are numerous additional configurations that create a similar desired effect: that of providing a planar member, whose planar surface may serve as a guard between a cyclist's body/clothing and the drivetrain of a bicycle, with the planar member capable of maintaining its relative position to a pedal tread surface 111 as the bicycle's cranks rotate when the bicycle is pedaled. For example, case 118 may not contain all subparts such as 120b, and/or planar disc 90 self expanding versus manually expanding, etc.

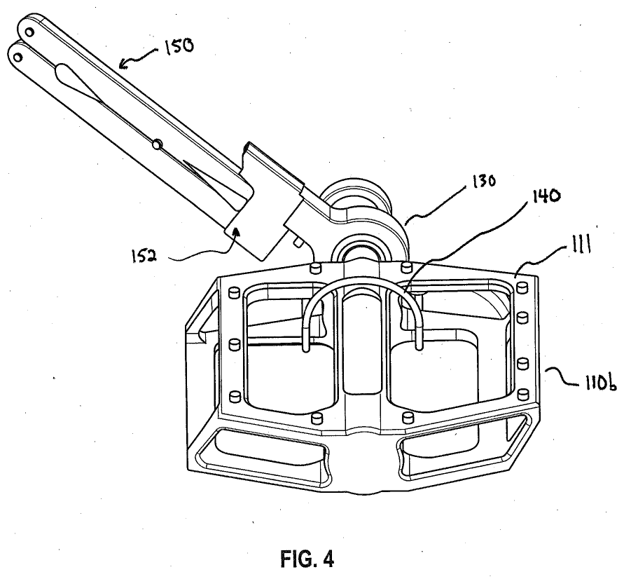

A second embodiment, shown in FIGS. 4-5, incorporates a panel assembly 150 to form a planar member, wherein the panel assembly may be similar to that of an expanding hand fan, with material that incorporates alternating folding sections. In FIG. 4, panel assembly 150 may mount to a pedal with threaded assembly 130, similar to that of the first embodiment—also referred to as an axle mount system. A seen in FIG. 4, clip 152 may hold the panel assembly 150 in place in its closed position. FIG. 5 shows the panel assembly 150 in an expanded position. Herein, expanded panel surface 155 is formed, providing a guard similar in function to that of the first embodiment. Folds 157 allow the panel assembly to readily expand and contract—such designs are well known in the art and will not be further detailed. Strap 140 may be included, which may be oriented around the center axle portion of the pedal as shown. Strap 140 engages with threaded assembly 130 to keep the orientation of 130 and panel assembly 150 in the desired relative position to each other. Strap 150 may be present on other embodiments as well. A counterweight, similar to that of the first embodiment and for the same effect, may also be included, but omitted here for brevity.

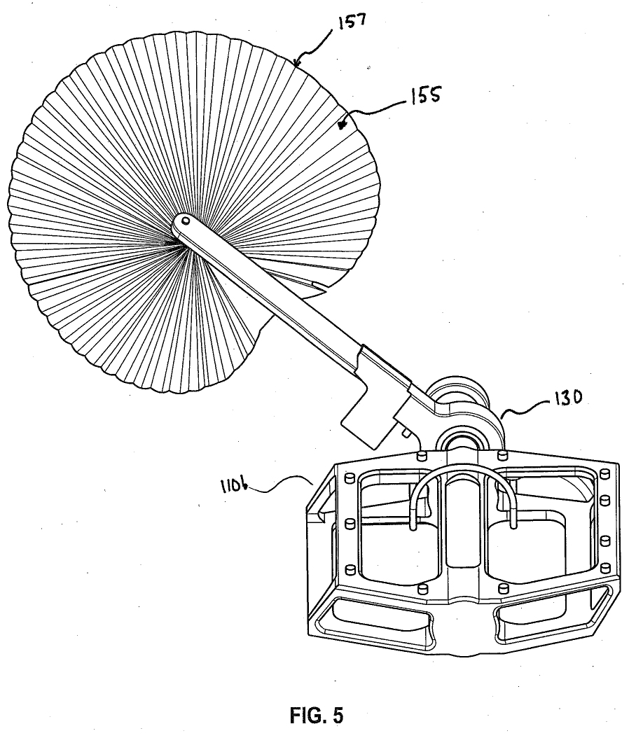

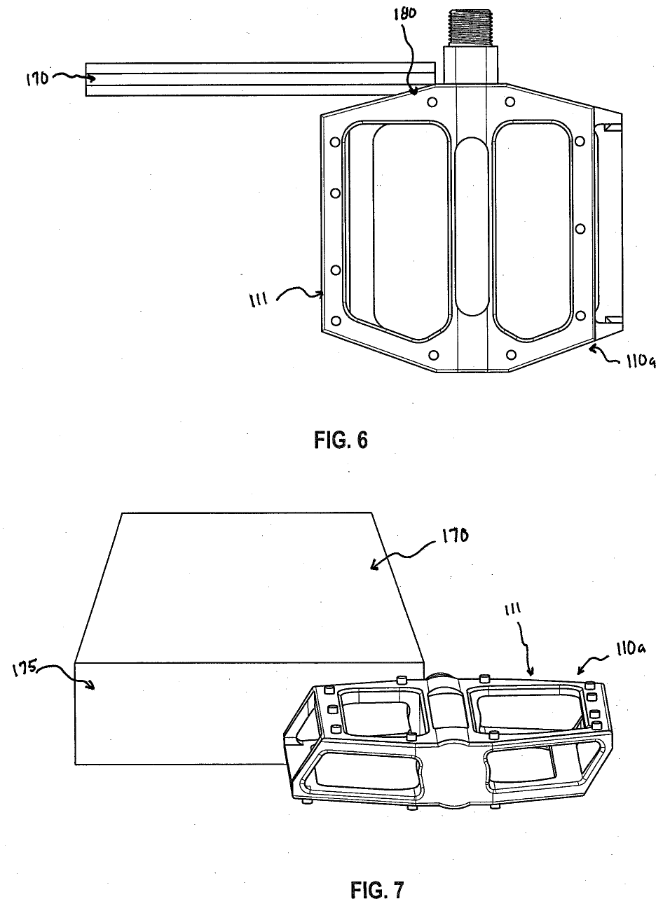

A third embodiment is shown in FIGS. 6-7. Herein, rather than the axle mount system and threaded assembly 130 of embodiments 1 and 2, the third embodiment incorporates a direct mount from a pedal body to a planar member. This style may be called a pedal body mount. FIG. 7 shows a fixed screen 170, which may include base 175. In this embodiment, screen 170 is of fixed size, and not foldable or collapsible. Screen 175 may be attached to base 175, or the two components may be one single piece. In this embodiment, base 175 is affixed directly to an inner portion 180 of the body of pedal 110a. By being fixed to the pedal body, screen 170 maintains its relative position to tread surface 111 as a bicycle is pedaled, and the cranks rotated. Affixing may be achieving by the base 175 being an integral part of the pedal body (via plastic molding, etc), or by a mounting bracket that joins the pedal body to the base 175.

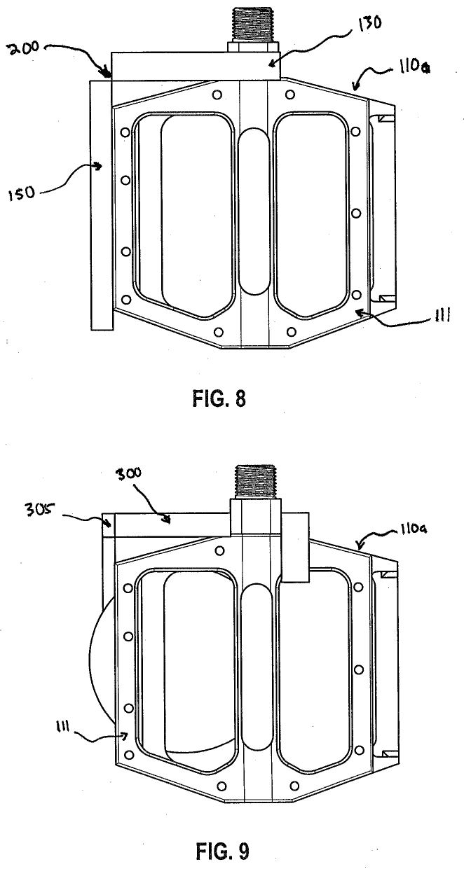

A fourth embodiment is shown in FIG. 8. Herein, threaded assembly 130 is used, similar to embodiments one and two, with details of 130 omitted in this drawing. A panel assembly 150 may be attached via a hinge/pivot point 200 to threaded assembly 130. This allows panel assembly 150 to fold against an edge of pedal 110a at a right angle as shown, in a stored position. For use, panel assembly 150 rotates at hinge 200, and functions in the same manner as that shown in the second embodiment, FIGS. 4-5. Assembly 150 may self-rotate at pivot point 200 and/or its planar surface may self-expand using springed hinges or other mechanisms.

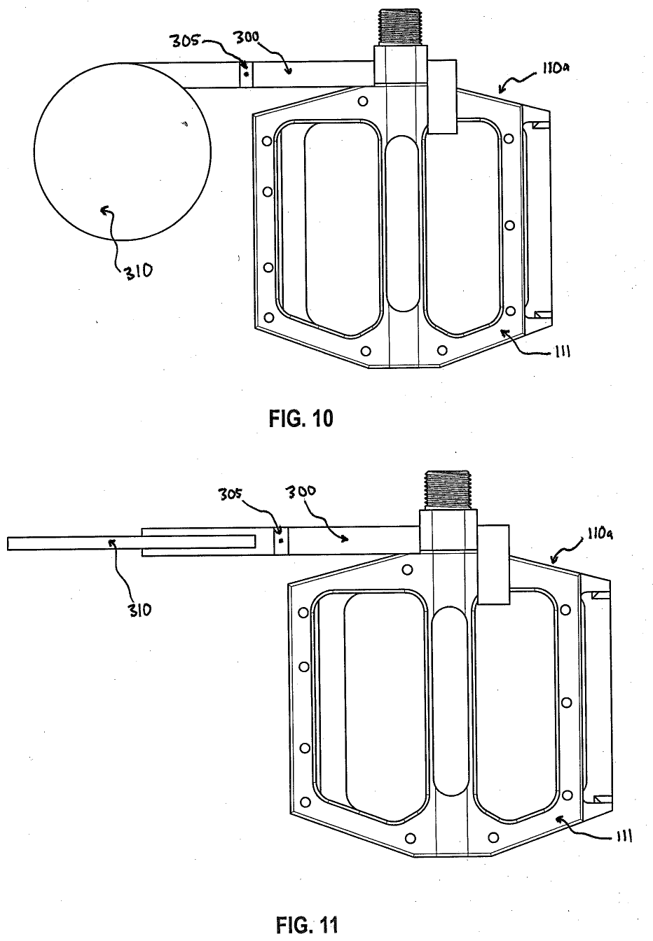

A fifth embodiment is shown in FIGS. 9-11. Herein, bracket 300 is affixed to the body of pedal 110a, and includes pivot 305, and case 310. FIG. 9 shows case 310 folded under an edge of pedal 110a at a right angle as shown, in a stored position, with case 310 positioned adjacent to and coplanar with a tread surface 111 of pedal 110a. FIG. 10 shows case 310 in its first unfolded stage, partly opened, as it pivots at 305 relative to bracket 300. FIG. 11 shows case 310 in a third position, rotated 90 degrees in an orientation perpendicular to its partly open position. Case 310 may contain a collapsible/expandable disc, similar to planar disc 90, and deployable in a manner similar to embodiment one.

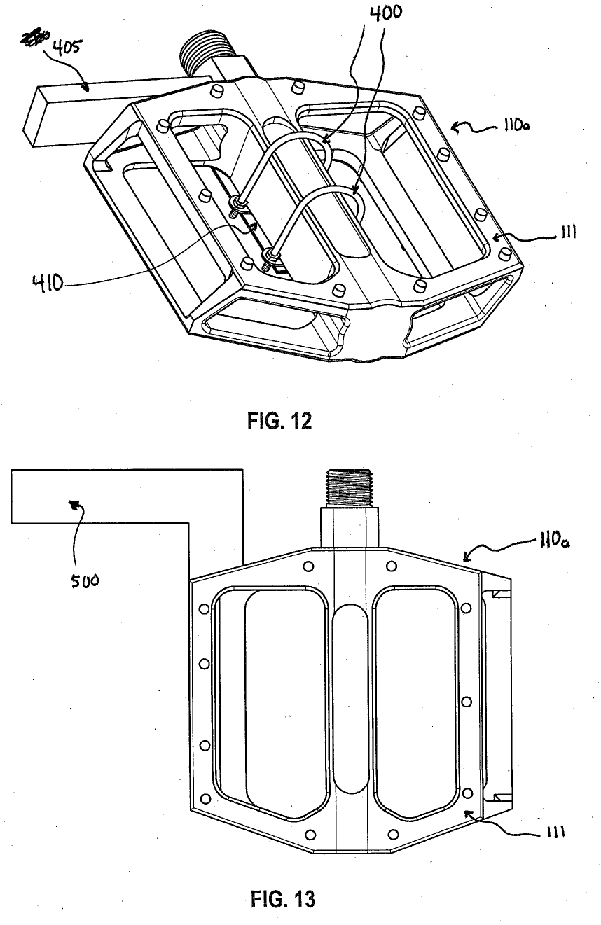

A sixth embodiment is shown in FIG. 12. This embodiment is an example of a mounting system that may be readily retrofitted to an existing pedal. FIG. 12 shows two fasteners 400, which surround the central portion of pedal 110a, and are secured by plate 410 using threaded nuts. Plate 410 may be secured to the pedal body by other suitable means, such as zip ties or other fastener types. Bracket 405 may then attach to or be one with plate 410. Any type of planar member (disc, screen, etc) may then attach to bracket 405. Bracket 405 may also be attached by other various means to the body of pedal 110a such as by any other of type of suitable clamping mechanism—one example being a u-shaped clamp that cinches the pedal body, compressing against the leading and trailing edges of the pedal. If such a clamp obscured the reflectors that many pedals have, the clamp may include reflectors. Bracket 405 may also attach to the pedal body using holes intended for mounting reflectors.

A seventh embodiment is shown in FIG. 13, in which fixture 500 is affixed directly to the body/cage of pedal 110a. Affixing may be achieving by fixture 500 being an integral part of the pedal body (via plastic molding, etc). Any type of planar member (disc, screen, etc) may then attach to fixture 500.

Any type of planar member, in addition to or instead of serving as a guard between a cyclist's clothing/body and a bicycle's drivetrain, may serve as a medium for text, images, a reflective or laminated surface, and/or patterns. This may include advertising, brand logos, artistic images, notices, warnings, etc.

The various embodiments are examples of combinations of the different elements described. For example, the embodiment of FIGS. 9-11, with a foldable storing mechanism for a planar disc, may be combined with the attachment configuration of embodiment shown in FIG. 13. As illustrating every possible component combination is untenable, the embodiments shown are understood to be combinable with components of other embodiments in a logical manner.

Numerous alternative forms, equivalents, and modifications will become apparent to those skilled in the art once the above disclosure is fully appreciated. It is intended that the future claims be interpreted to embrace all such alternative forms, equivalents, and modifications where applicable. The present system is deemed limited only by claims and the reasonable interpretation thereof which will be filed as part of a full utility application that may claim the benefit of this provisional application, without the claims included herein limiting the scope of future claims.

1. A device for a pedaling system, comprising: a planar member configured to attach to an inward portion of a pedal; the planar member capable of changing from a closed position to an expanded position thereby forming a planar surface, such that the planar surface is substantially perpendicular to a tread surface of the pedal; whereby the planar member is capable of maintaining a fixed position relative to a tread surface of the pedal when the pedal is mounted to a crank arm and moved in a circular pedaling motion.
